(19) United States
(12) Patent Application Publication
(10) Pub. No.: US 2024/0395156 A1
(43) Pub. Date: Nov. 28, 2024

(54) METHODS AND SYSTEMS FOR ONLINE ARTIFACT CREATION AND MANAGEMENT

(71) Applicant: The Practicing Musician, S.P.C., Shoreline, WA (US)

(72) Inventor: Jake Douglass, Shoreline, WA (US)

(21) Appl. No.: 18/673,158

(22) Filed: May 23, 2024

Related U.S. Application Data
(60) Provisional application No. 63/503,904, filed on May 23, 2023.

(51) Int. Cl. G09B 5/02; G09B 5/14

(52) U.S. Cl. CPC G09B 5/02; G09B 5/14

(57) ABSTRACT

A technique is directed to methods and systems for managing teaching contents (e.g., in the form of content artifacts). In some implementations, the method includes (1) receiving, by a content management platform, a framework for a set of artifacts; (2) determining, by the content management platform, one or more content artifacts based on the received framework; (3) transmitting, by the content management platform, a request to one or more content generators to provide the one or more content artifacts; (4) receiving, by the content management platform, the one or more content artifacts; and (5) performing a quality assurance (QA) process on the one or more content artifacts. In response to a result of the QA process, access for the one or more content artifacts can be provided to one or more users with an educator role and/or a student role.

### CROSS-REFERENCE TO RELATED APPLICATIONS

This application claims the benefit of U.S. Patent Application No. 63/503,904, filed on May 23, 2023, entitled SYSTEMS AND METHODS FOR INTEGRATING ONLINE EDUCATIONAL RESOURCES FROM MULTIPLE PROVIDERS, which is hereby incorporated by reference in its entirety.

### BACKGROUND

Online learning systems have been developed in recent years for remote education. Some conventional online learning systems offer video recordings for students to review. Some conventional online learning systems provide live video conferences with teachers and coaches. However, the conventional systems do not provide customized education plans or curricula for students' needs. Therefore, it is advantageous to have an improved system and method to address the foregoing issue.

### TECHNICAL FIELD

The present technology is directed to online learning systems. More particularly, systems and methods for generating/managing various teaching schemes for multiple learning objects are provided.

### BRIEF DESCRIPTION OF THE DRAWINGS

FIG. 1 is a schematic diagram illustrating a system in accordance with some implementations of the present disclosure.

FIG. 2 is a schematic diagram illustrating roles and functions in the system in accordance with some implementations of the present disclosure.

FIG. 3 is a block diagram illustrating an overview of devices on which some implementations can operate.

FIG. 4 is a block diagram illustrating an overview of an environment in which some implementations can operate.

FIG. 5 is a flow diagram illustrating processes in some implementations in accordance with the present disclosure.

The techniques introduced here may be better understood by referring to the following Detailed Description in conjunction with the accompanying drawings, in which like reference numerals indicate identical or functionally similar elements. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Conventional online learning systems and platforms provide fixed sets of teaching materials (e.g., one set fits all) and do not provide customizable teaching materials based on student's learning preference or characteristics. For the conventional systems, it is particularly difficult to combine or interleave contents created by multiple creators into an integrated teaching module at least because their teaching materials are pre-recorded and fixed.

The present technology is directed to online learning systems and associated methods to address the foregoing needs. The present systems can generate various teaching schemes for the same learning object such that students can select or are delivered the most suitable teaching scheme that fits their preferences/needs/characteristic. In some embodiments, such characteristics can include learning tendency or any other suitable factors that affect one's ability to learn. For example, student A can be a visual learner who prefers seeing actual demonstration from a coach or tutor, whereas student B can be an auditory learner who learns more effectively by listening. As another example, student C prefers learning in language X by speaking and listening, whereas student D may prefer learning in written language Y. In yet another example, student E may prefer study materials with bullet points, whereas student F prefers learning material with a detailed step-by-step guidance.

To fulfill the foregoing needs, the present systems and methods enable multiple educational content providers (e.g., teachers, tutors, coaches, etc.) to create their own teaching methods/schemes/materials/curricula/assignments (“teaching contents” or “TC”) for the same learning goal/subject/objective. The present systems also manage those generated teaching contents and enable students to access them based on students' needs and preferences. By this arrangement, the present systems can provide effective learning experience for various types of students. In some embodiments, the teaching contents can be in form of content artifacts.

There are three major aspects of the present technology: (1) “teaching” aspect, (2) “learning” aspect, and (3) “material” or “content” management aspect. For the teaching aspect, the present systems enable multiple educational content providers to create their own teaching contents for various learning objects. The present technology includes peer-review and quality assurance mechanisms that maintain the quality of the generated teaching contents.

For the learning aspect, the present technology enables students to access the contents based on students' needs and preferences. Students can also review teaching contents and provide feedback so as to improve the quality of the teaching contents. Students' performance can also be tracked and recorded for future references (e.g., teaching content improvement, teaching content provider evaluation, etc.).

For the material/content management aspect, the present technology manages multiple accounts and “roles” (e.g., as a course creator/generator, a content contributor, a content sponsor (e.g., a person who uses or endorses a teaching content; an individual and/or an organization who/which provides financial or technical support/contribution/donation to the systems; an advertising agency which wants to add advertising materials in the system), an educator/teacher, a content reviewer, a student, etc.) in the systems. The present system also manages the generated teaching contents (categorizing, prioritizing, indexing, associating, etc.) such that students can have customized effective learning experiences. The present system also matches students and teachers in a real-time (or near real-time) manner such that the students can communicate with and get instant feedback from the teachers online.

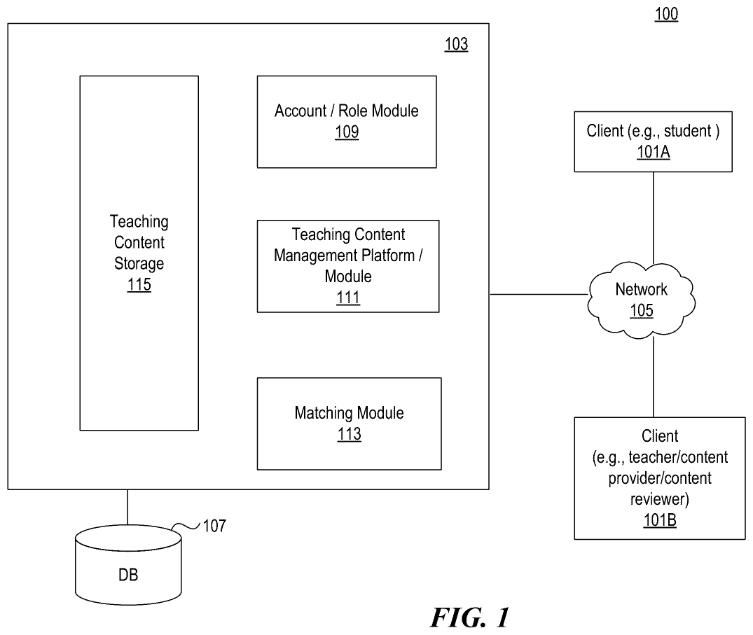

Several implementations are discussed below in more detail in reference to the figures. FIG. 1 is a schematic diagram illustrating a system 100 for online learning. The system 100 includes one or more client devices 101 (two are shown in FIG. 1, 101A and 101B) in communication with a server 103 via a network 105. For example, client devices 101 can include handheld mobile devices (e.g., smartphones, portable hotspots, tablets, etc.), laptops, wearables, head-mounted displays with wireless augmented reality/virtual reality (AR/VR) connectivity, portable gaming consoles, etc. The client devices 101 can be used by a student user (i.e., client device 101A) or other users (i.e., client device 101B) in different roles (teacher, content provider, content reviewer, etc.). In some embodiments, the network 105 can be the Internet. In some embodiments, the network 105 can be a5G network, an LTE network, a satellite network, other suitable network, etc. In some embodiments, the server 103 can further connect to a database 107. The database 107 is configured to store data and information related to the server 103 and other associated information, data analyzed or trained by the server 103, user profile information (e.g., user preferences, user subscription plans, types or configurations of user devices, etc.) and/or other suitable information.

As shown, the server 103 includes an account/role management module 109, a teaching content management platform/module 111, a matching module 113, and a teaching content storage 115. The account/role management module 109 is configured to manage the roles and corresponding accounts associated with the server 103.

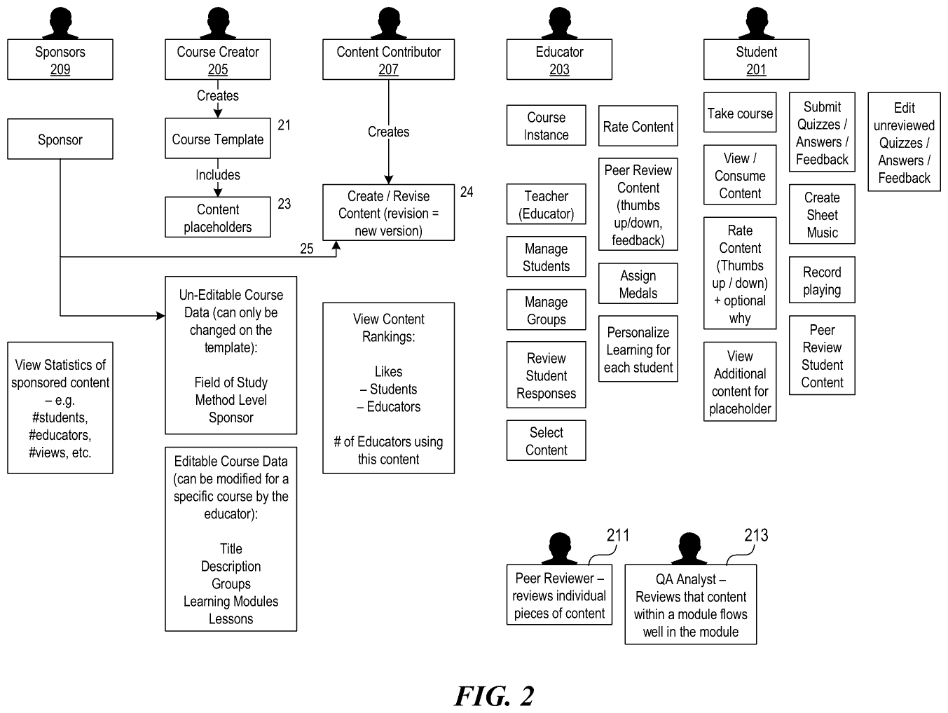

The roles can include, for example, a student, a teacher/an educator, a course creator/generator, a content contributor, a content manager, a sponsor, a peer reviewer, a quality assurance analyst, an administrator, etc. The “student” role is for a user who signs up for learning. The “teacher/educator” role is for a user who teaches a lesson/class/section (either online or by offline recording). The “course creator/generator” role is for a user who is able to create a teaching framework (usually an experienced teacher/educator or an expert in his/her teaching field). The “content contributor” role is for a user who contributes to a teaching content (at least partially). The “sponsor” role is for endorsing a teaching framework (e.g., user U1 affirms that teaching framework TF is effective for students aged 9-12, with visual learning preference) or a teaching content (e.g., user U2 provides comments to a teaching content, adding some teaching tips when using the teaching content to teach). In some embodiments, the “sponsor” role can also provide financial/technical support to the system in exchange for an advertising opportunity (e.g., presenting an advertising material, naming rights, etc.). The “peer reviewer” role is for a user who can verify a teaching content (for effectiveness, efficiency, accuracy, etc.). The “quality assurance analyst” is for a user who reviews whether a piece of teaching content fits or flows well in a teaching framework. Embodiments of the foregoing roles are to be discussed in detail with reference to FIG. 2. Each user account can be associated/assigned with one or more roles.

In some embodiments, the teaching framework and/or the teaching content can be generated by machine learning (ML) methods and/or artificial intelligence (AI) schemes. For example, an operator can first provide a learning objective (e.g., beginner soccer drill). The system can then use previous teaching contents and user/reviewer comments/feedback to generate, by ML and AI methods/schemes, teaching contents that are suitable to achieve the learning objective. Factors to consider include, for example, a time frame to achieve the learning objective, learning preferences of learners, availability/capability of equipment of the system and the learners, effectiveness/popularity of the previous teaching contents, etc.

The teaching content management platform/module 111 is configured to manage teaching contents of the system 100, including (1) creating teaching contents; (2) categorizing the teaching contents; (3) prioritizing the teaching contents, (4) indexing the teaching contents; and (5) associating the teaching contents.

### Creating Teaching Content

In some embodiments, the teaching content management platform/module 111 can determine, according to a teaching framework, a number of teaching contents to be created. For example, according to teaching framework TF1 for a beginner's piano lesson, five teaching contents TC1-TC5 (e.g., introduction section TC1, terminology section TC2; the “four chord” section TC3, “C major” section TC4, and “G” major section TC5) are required.

The teaching content management platform/module 111 can then reach out to available content providers (e.g., users with the “teacher/educator” role, the “course contributor” role, etc.) and solicit input, comments, feedback, or a proposed content submission. Once the proposed content submission is received, the teaching content management module 111 sends the proposed content submission to one or more users with the “peer reviewer” role for feedback and review. The review process may go back and forth between the peer reviewer and the content provider, such that the proposed content submission can be refined and tuned. In some embodiments, once the review process is complete, the teaching content management platform/module 111 can send the reviewed proposed content submission to one or more users with the “quality assurance (QA) analyst” role for comments and review so as to confirm the reviewed proposed content submission fits or flows well in the teaching frameworks. In some embodiments, the teaching framework can also be peer-reviewed and quality-assured in a similar fashion.

### Categorizing Teaching Content

Once the review/QA process is completed, the teaching content management module 111 can categorize the proposed content submission as “approved” or “verified” and add that teaching content to the teaching content storage 115 for future uses.

### Prioritizing Teaching Content

The teaching content management platform/module 111 can also be configured to prioritize the approved teaching contents (e.g., adjusting an order presenting the teaching contents to a student user or a teacher user) based on one or more of the following factors: positive/negative feedback from users, user preferences, user history, users' skill level, events (e.g., an upcoming competition for a type of instrument; an audition for musician; a sports tryout event, etc.) and/or other suitable factors.

### Indexing Teaching Content

The teaching content management platform/module 111 can also be configured to index the approved teaching contents by adding tags/flags thereto so as to indicate a status thereof. For example, the content management platform/module 111 can add a “language” tag to a content indicating that the teaching content is in a specific language. As another example, the content management platform/module 111 can add a “visual-preference” tag to a content indicating that the teaching content is suitable for the “visual learner” type of users. As another example, the content management platform/module 111 can add a “skill-level” tag to a content indicating that there are some prerequisite skills for the teaching content.

### Associating Teaching Content

The teaching content management platform/module 111 can also be configured to associate with two or more teaching contents in various learning fields. For example, “physical flexibility training 101” teaching content can be associated with “soccer basic” teaching content, “ski basic” teaching content etc. By associating various teaching contents, the system 100 can provide effective learning experiences for users with different preferences and interests.

In some embodiments, the matching module 113 is configured to match online students and teachers. For example, a student from the client device 101A can send a request to the server 103, asking to find an online teacher who is available to teach and answer a few questions regarding teaching content TCX (immediately or at a later, scheduled time). In such embodiments, the matching module 113 can query a database (e.g., the database 107) for available teachers (e.g., considering their profiles, specialties, skill/proficiency levels, locations, etc.). When there is a match, the matching module 113 can notify a teaching candidate and get a confirmation of his/her availability. For example, a teacher using client device 101B is available and qualified to teach the teaching content TCX. The matching module 113 can then connect the client device 101A and 101B and initiate a tutoring section. In some embodiments, the client device 101A and 101B can be connected via a third-party conference provider.

In some embodiments, when the tutoring section is complete, the matching module 113 can be configured to seek feedback from both the teacher and the student for future reference, improvement, training, etc. In some embodiments, the feedback can be posted in a social media as advertisement.

The teaching content storage 115 is configured to store teaching contents and associated information (e.g., flag, tag, index, etc.). In some embodiments, the teaching content storage 115 can be a hard disk drive (HDD), a cloud drive, a buffer, a memory, and/or other suitable components.

FIG. 2 is a schematic diagram illustrating roles and functions in the system 100 in accordance with some implementations of the present disclosure. As shown in FIG. 2, users/accounts of the system 100 can have roles such as a student 201, an educator 203 (or a teacher), a course creator 205, a content contributor 207, a sponsor 209, a peer reviewer 211, and a quality assurance (QA) analyst 213.

As shown in FIG. 2, the student 201 is authorized by the system 100 to take courses, view teaching contents, provide feedback (by rating teaching contents), view additional placeholder content (e.g., teaching contents for a future subject), submit/edit answers/assignments/homework, create student contents such as learning records (e.g., sheet music, report, study journal, etc.), provide peer review for student contents recorded performance (e.g., instrument playing), etc.

The educator 203 is authorized by the system 100 to teach a teaching content. In some embodiments, the educator can initiate a course instance (e.g., an online tutoring section), manage students (e.g., inviting/adding new students, adding notes regarding student's learning progress, etc.), manage groups (e.g., a class, a study group, a competition, a tryout section, a recital event, etc.), review student responses (e.g., teaching feedback, grading assignments, etc.), select contents (e.g., choose contents to fit in a teaching framework or students' needs, etc.), rate contents (e.g., provide rating for teaching contents or teaching framework such as 1-10 stars), peer-review contents (e.g., provide feedback or comments on teaching contents or frameworks created by others), assign medals (e.g., provide recognition for students or peer educators, etc.), and provide personalized learning plans for each student.

FIG. 2 also illustrates the relationships and interactions among three roles, the course creator 205, the content contributor 207, and the sponsor 209. The course creator 205 is authorized by the system 100 to create a course template 21. The course template 21 can include one or more content placeholders 23. For example, the course template 21 can be for a beginner's ski lesson, including four teaching contents: introduction TC1, stance TC2, wedge turns TC3, and ski equipment TC4. The course creator 205 (e.g., a ski instructor) can determine to cover the teaching contents TC1-TC3 himself/herself and leave the TC4 blank by a content placeholder. The content contributor 207 can pick up the TC4 and add new contents 24 to the TC4 (e.g., revisions/changes can be saved as a new version). In some embodiments, the sponsor 209 can make a financial/technical contribution to the system, review teaching contents TC4 (indicated by arrow 25) and have its name on it (e.g., a naming right). In some embodiments, the sponsor 209 can be authorized to add advertising content attached to the teaching contents.

Meanwhile, there are some “un-editable” course data items that can only be changed or updated by the sponsor 209 (or course creator in some cases), such as “field of study,” (e.g., music, sports, math, etc.) “method level” (e.g., beginner, advanced, expert, etc.), and “sponsor.” In such embodiments, the sponsor 209 acts as a “gate keeper” to make sure these course data items are properly maintained. There are also some “editable” course data items that can be edited by the educator 203 such as “title,” “description,” “groups,” “learning modules (e.g., a group/set of teaching contents, etc.),” and “lessons (e.g., one or more teaching contents).”

The content contributor 207 is also authorized by the system 100 to view content ranking/rating, such as the number of positive comments (“likes”) by students/educators, the number of utilizations of a teaching content, etc. In some embodiments, the sponsor 209 is also authorized by the system 100 to view statistics of sponsored contents, such as the number of students, the number of educators, the number of views, etc., such that the sponsor 209 can determine its future technical/financial support to the related teaching contents and teaching frameworks.

As also shown in FIG. 2, the peer reviewer 211 is authorized by the system 100 to review teaching contents so as to provide feedback and comments. In some embodiments, the peer reviewer 211 can be rewarded (e.g., points, gift cards, recognitions, etc.) by the system 100 as motivation for peer reviewing. The QA analyst 213 is authorized by the system 100 to review a teaching framework (or a teaching module) so as to make sure it flows well. In some embodiments, the QA analyst 213 can also be rewarded (e.g., points, gift cards, recognitions, etc.) by the system 100 as motivation for performing a QA task.

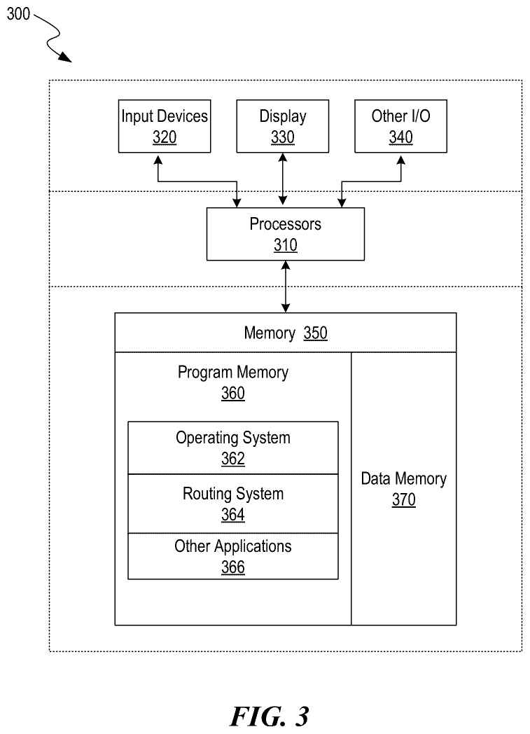

FIG. 3 is a block diagram illustrating an overview of devices (e.g., the server 103, the client device 101, etc.) on which some implementations can operate. Device 300 can include one or more input devices 320 that provide input to the processor(s) 310 (e.g., CPU(s), GPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. Processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, the display 330 provides graphical and textual visual feedback to a user. In some implementations, the display 330 includes the input device as part of the display, such as when the input device is a touchscreen or is equipped with an eye direction monitoring system. In some implementations, the display is separate from the input device. Examples of display devices include an LCD display screen, an LED display screen, a projected, holographic, or augmented reality display (such as a heads-up display device or a head-mounted device), and so on. Other I/O devices 340 can also be coupled to the processor, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. The device 300 can utilize the communication device to distribute operations across multiple network devices.

The processors 310 can have access to a memory 350 in a device or distributed across multiple devices. A memory includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, routing system 364 (e.g., for implementing the routing plan discussed herein), and other application programs 366. The memory 350 can also include data memory 370, user interface data, event data, image data, biometric data, sensor data, device data, location data, network learning data, application data, alert data, structure data, camera data, retrieval data, management data, notification data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

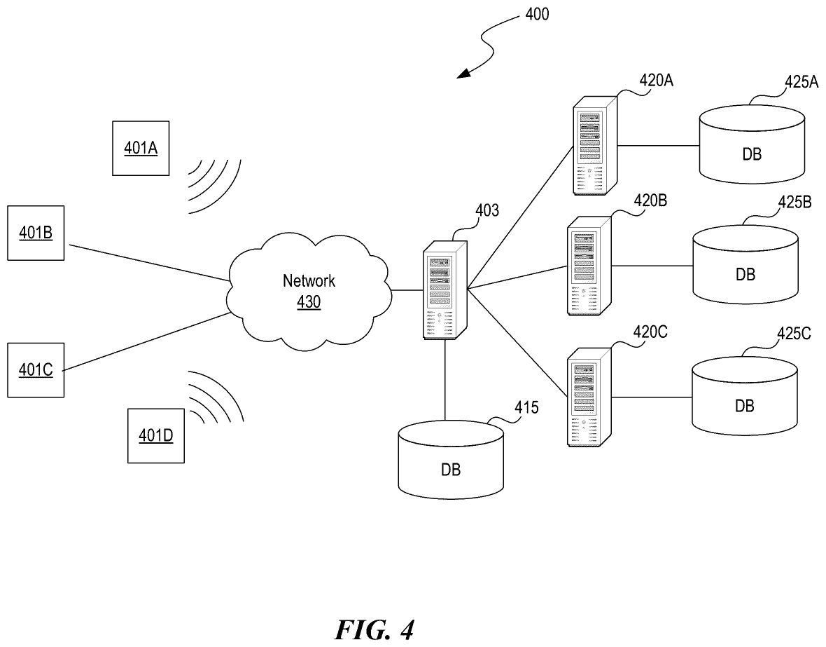

FIG. 4 is a block diagram illustrating an overview of an environment 400 in which some implementations can operate. The environment 400 can include one or more client computing devices 401A-D, examples of which can include the client device 101. The client computing devices 401 can operate in a networked environment using logical connections through network 430 to one or more remote computers, such as a server computing device 403.

In some implementations, the server computing device 403 can be an edge server which receives client requests and coordinates fulfillment of those requests through other servers, such as servers 420A-C. Server computing devices 403 and 420 can comprise computing systems, such as the device 300 discussed above. Though each server computing device 403 and 420 is displayed logically as a single server, server computing devices can each be a distributed computing environment encompassing multiple computing devices located at the same or at geographically disparate physical locations. In some implementations, each server 420 corresponds to a group of servers.

The client computing devices 401 and the server computing devices 403 and 420 can each act as a server or client to other server/client devices. Server 403 can connect to a database 415. Servers 420A-C can each connect to a corresponding database 425A-C. As discussed above, each server 420 can correspond to a group of servers, and each of these servers can share a database or can have their own databases.

The databases 415/425 can store information such as implement data, user interface data, event data, image data, detection data, biometric data, sensor data, device data, location data, network learning data, application data, alert data, structure data, camera data, retrieval data, management data, notification data, configuration data. Though databases 415/425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN) but can also be other wired or wireless networks. The network 430 may be the Internet or some other public or private network. The client computing devices 401 can be connected to the network 430 through a network interface, such as by wired or wireless communication. While the connections between server 403 and servers 420 are shown as separate connections, these connections can be any kind of local, wide area, wired, or wireless network, including network 430 or a separate public or private network.

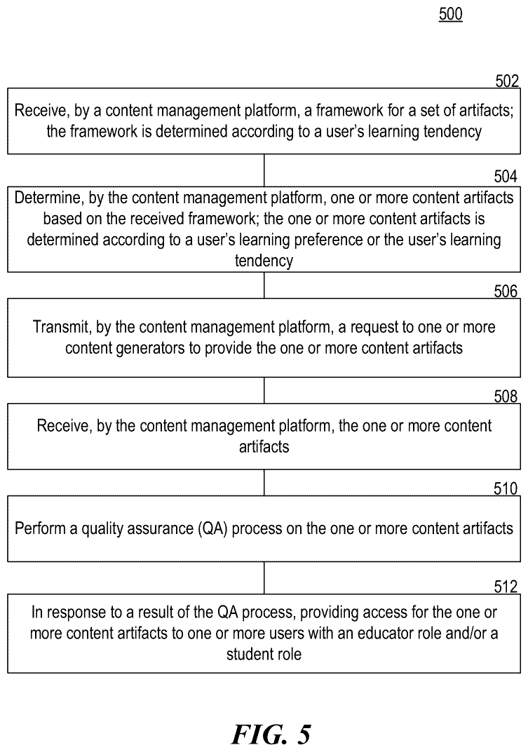

FIG. 5 is a flow diagram illustrating a method 500 used in some implementations for managing image information associated with an item of interest. In some embodiments, the method 500 can be implemented by a server (e.g., the server 103) discussed herein. In some embodiments, the method 500 can be used to generating a set of artifacts (e.g., content artifacts for teaching).

At block 502, the method 500 starts by monitoring (and/or by receiving), by a content management platform, a framework for the set of artifacts. In some embodiments, the monitoring step can be optional. In some embodiments, the framework can be determined according to a user's learning tendency (e.g., a visual learner, a voice learner, etc.). In some embodiments, the framework can be determined according to users' preferences and/or needs. At block 504, the method 500 can continue determining, by the content management platform, one or more content artifacts based on the received framework. In some embodiments, the one or more content artifacts is determined according to a user's learning preference or the user's learning tendency. In some embodiments, the one or more content artifacts can be determined according to other factors such as users' learning needs (e.g., large-sized font, loud voice, etc.). At block 506, the method 500 continues sending, by the content management platform, a request to one or more content generators/creators to provide the one or more content artifacts (or corresponding teaching contents).

At block 508, the method 500 continues receiving, by the content management platform, the one or more content artifacts. At block 510, the method 500 continues by performing a quality assurance (QA) process on the one or more content artifacts. In some embodiments, as shown in block 512, the method 500 further comprises in response to a result of the QA process, providing access for the one or more content artifacts to one or more users with an educator role. Embodiments of the educator role are discussed in detail with reference to FIG. 2.

In some embodiments, the QA process includes a peer-review process by one or more users with the educator role. In some embodiments, the QA process includes a QA review performed by one or more users with a QA analysis role. In some embodiments, a refinement process of the received framework can be performed based on factors such as student ranking/feedback, teacher/reviewer comments, etc. In some embodiments, the framework can be created by one or more users with a sponsor role. In some embodiments, the foregoing QA processes can be handled by an AI module. Embodiments of the sponsor role are discussed in detail with reference to FIG. 2.

In some embodiments, the QA process includes determining whether the one or more content artifacts facilitate achieving a learning objective of the teaching framework. Examples of the learning object include achieving a certain level of mastery of a skill, demonstrating a proficiency of a sets of skills, having knowledge of a specific subject, scoring at a test higher than a threshold, etc.

In some embodiments, the method 500 further comprises enabling one or more users with a content-contributor role to provide comments on, or to edit the one or more, content artifacts or teaching contents. Embodiments of actions of the content-contributor role are discussed in detail with reference to FIG. 2.

In some embodiments, the method 500 further comprises granting access of the one or more content artifacts to a client device of a user with a student role or an educator role. In some embodiments, the method 500 further comprises receiving feedback of the one or more content artifacts from the users with the student role and/or the users with the educator role. The teaching contents can be updated/revised based on the foregoing feedback.

In some embodiments, the method 500 can include (1) acquiring a multimedia content (e.g., a teaching content or a content artifact), (2) identifying sections of the multimedia content to interleave according to the (teaching) framework, (3) creating a new multimedia object according to the identified sections; and (4) updating the one or more content artifacts based on the new multimedia object. In some embodiments, the “new” media object can be an edited/adjusted/updated media object based on existing media objects.

For example, a flute teacher wants to add a video clip showing a set of finger-movement skills for visual beginners in Mandarin. The flute teacher can transmit the video clip to the server. In some embodiments, the server can initiate the foregoing process by soliciting the video clip (e.g., based on student needs or feedback). The server can first acquire the video clip and then identify which sections of the multimedia content can be inserted or interleaved into the existing teaching framework (e.g., to be part of Teaching Material TM1, replace Teaching Material TM2, set as an alternative of Teaching Material TM3). The server can then create a new multimedia object (e.g., an object to be inserted) according to the identified sections. The server can then update the existing teaching contents based on the new multimedia object.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A computer-implemented method for generating a set of artifacts, the method comprising:
receiving, by a content management platform, a framework for the set of artifacts, wherein the framework is determined according to a user's learning tendency;
determining, by the content management platform, one or more content artifacts based on the received framework, wherein the one or more content artifacts is determined according to a user's learning preference or the user's learning tendency;
transmitting, by the content management platform, a request to one or more content generators to provide the one or more content artifacts;
receiving, by the content management platform, the one or more content artifacts;
performing a quality assurance (QA) process on the one or more content artifacts; and
in response to a result of the QA process, providing access for the one or more content artifacts to one or more users with an educator role and/or a student role.

2. The method of claim 1, wherein the QA process includes a peer-review process by one or more users with the educator role.

3. The method of claim 1, wherein the QA process includes a QA review performed by one or more users with a QA analysis role.

4. The method of claim 1, wherein the framework is created by one or more users with a course-creator role.

5. The method of claim 1, wherein the QA process includes determining whether the one or more content artifacts facilitate achieving a learning object of the teaching framework.

6. The method of claim 1, further comprising enabling one or more users with the student role or the educator role to provide comments on the one or more content artifacts.

7. The method of claim 1, further comprising enabling one or more users with a content-contributor role to edit the one or more content artifacts.

8. The method of claim 1, further comprising granting access of the one or more content artifacts to a client device of a user with the student role or the educator role.

9. The method of claim 8, further comprising receiving feedback of the one or more content artifacts from the client device of the user with the student role or the educator role.

10. The method of claim 8, wherein the client device is a first client device, wherein the user with the student role is a first user, and wherein the method further comprises granting access of the one or more content artifacts to the first client device based on an instruction from a second client device of a second user with an educator role.

11. The method of claim 10, further comprising receiving feedback of the one or more content artifacts from the second client device of the second user with the educator role.

12. The method of claim 1, further comprising receiving, by the content management platform, revisions for the one or more content artifacts from one or more users with a content-contributor role.

13. The method of claim 1, further comprising updating the one or more content artifacts based on the revisions.

14. A system, comprising:
a processor;
a memory coupled to the processor;
an account module configured to manage multiple roles of a plurality of users, wherein the multiple roles include a sponsor role, a course creator role, and a content contributor role; and
a content management platform configured to
receive a framework for a set of artifacts from a user with the course-creator role, wherein the framework is determined according to a user's learning tendency;
determine one or more content artifacts based on the received framework, wherein the one or more content artifacts is determined according to a user's learning preference or the user's learning tendency;
transmit, by the content management platform, a first request to one or more users with the course generator role to provide the one or more content artifacts;
transmit, by the content management platform, a second request to one or more users with the content contributor role to provide supplement to the one or more content artifacts;
receive the one or more content artifacts;
receive the supplement of the one or more content artifacts; and
perform a quality assurance (QA) process on the one or more content artifacts.

15. The system of claim 14, wherein the multiple roles include an educator role, and wherein the content management platform is further configured to:
in response to a result of the QA process, provide access for the one or more content artifacts to one or more users with the educator role and/or the student role.

16. The system of claim 15, wherein the QA process includes a peer-review process by the one or more users with the educator role.

17. The system of claim 15, wherein the QA process includes determining whether the one or more content artifacts facilitate achieving a learning object of the framework.

18. The system of claim 14, wherein the content management platform is further configured to:
receive first feedback of the one or more content artifacts from a first client device of a first user with the student role; and
receive second feedback of the one or more content artifacts from a second client device of a second user with the educator role.

19. The system of claim 18, wherein the content management platform is further configured to:
update the one or more content artifacts based on the first feedback and the second feedback.

20. A computing system comprising:
at least one processor; and
at least one memory storing instructions that, when executed by the processor, cause the computing system to perform a process comprising:
receiving, by a content management platform, a framework for a set of artifacts;
determining, by the content management platform, one or more content artifacts based on the received framework;
transmitting, by the content management platform, a request to one or more content generators to provide the one or more content artifacts;
receiving, by the content management platform, the one or more content artifacts; and
performing a quality assurance (QA) process on the one or more teaching contents.
